(19) United States
(12) Patent Application Publication
(10) Pub. No.: US 2023/0024823 A1
(43) Pub. Date: Jan. 26, 2023

(54) SETTLEMENT SYSTEM, RECOGNITION DEVICE, AND METHOD THEREOF

(71) Applicant: TOSHIBA TEC KABUSHIKI KAISHA, Tokyo (JP)

(72) Inventor: Takashi Ichikawa, Tagata Shizuoka (JP)

(21) Appl. No.: 17/713,270

(22) Filed: Apr. 5, 2022

(30) Foreign Application Priority Data
Jul. 21, 2021 (JP) 2021-120309

(51) Int. Cl. G06Q 20/20; G06Q 20/40; G06Q 20/32; G06Q 20/38

(52) U.S. Cl. CPC G06Q 20/208; G06Q 20/4014; G06Q 20/3276; G06Q 20/3829; G06Q 2220/00

(57) ABSTRACT

According to one embodiment, a settlement system includes an imaging portion, a specifying portion, an acquisition portion, and a recording portion. The specifying portion specifies the commodity from an image captured by the imaging portion. The acquisition portion acquires an image of a medium used for online settlement from the image captured by the imaging portion. The recording portion records the image of the medium acquired by the acquisition portion and the information related to the transaction of the commodity specified by the specifying portion on a recording medium.

### CROSS-REFERENCE TO RELATED APPLICATION

This application is based upon and claims the benefit of priority from Japanese Patent Application No. 2021-120309, filed on Jul. 21, 2021, the entire contents of which are incorporated herein by reference.

### FIELD

Embodiments described herein relate generally to a settlement system, a recognition device of the system, and a method of the recognition device.

### BACKGROUND

Generally, in credit card settlement, credit card data is read by a dedicated terminal and transmitted to an authentication server connected online to authenticate the credit card. Then, once the credit card is approved, settlement is possible. Therefore, if the system is offline due to a network failure or an authentication server failure, the settlement with the credit card is not possible.

In the related art, as a countermeasure, there is a method of using a dedicated printer that transfers characters embossed on a card. The credit card is embossed with the card number, expiration date, name of the holder, and the like, which are information required for authentication. Therefore, the method enables settlement by a credit card by transferring the embossed characters to a paper with a dedicated printer and getting the signature of the credit card user on the paper.

However, the method requires the above-mentioned dedicated printer. Since there are extremely rare cases of being offline, many stores do not have a dedicated printer at the cash desk. For this reason, for example, if the system suddenly becomes offline during business hours, settlement by a credit card will not be possible until a printer is ready, which will cause trouble for many customers.

### DESCRIPTION OF THE DRAWINGS

FIG. 1 is a schematic configuration diagram of a settlement system;

FIG. 2 is a block diagram showing a circuit configuration of a main part of a checkout machine;

FIG. 3 is a block diagram showing a circuit configuration of a main part of a recognition device according to a first embodiment;

FIG. 4 is a schematic diagram showing a main data structure of a card record;

FIG. 5 is a flowchart showing a procedure of information processing executed by the processor of the recognition device according to a control program;

FIG. 6 is a flowchart showing a specific procedure of offline settlement processing;

FIG. 7 is a flowchart showing a procedure of commodity registration command reception processing executed by the processor of the checkout machine according to the control program;

FIG. 8 is a flowchart showing a procedure of checkout command reception processing executed by the processor of the checkout machine according to the control program;

FIG. 9 is a schematic diagram showing an example of a layout of an offline settlement receipt dispensed;

FIG. 10 is a block diagram showing a circuit configuration of a main part of a recognition device according to a second embodiment;

FIG. 11 is a schematic diagram showing a main data structure of a card record;

FIG. 12 is a flowchart showing a specific procedure of offline settlement processing; and

FIG. 13 is a schematic diagram showing an example of a layout of an offline settlement receipt dispensed.

### DETAILED DESCRIPTION

An aspect to be solved by exemplary embodiments is to provide a settlement system that enables credit card settlement if offline without using a dedicated printer or the like, a recognition device of the system, and a method of the recognition device.

In general, according to one embodiment, the settlement system includes an imaging means, a specifying means, an acquisition means, and a recording means. The specifying means specifies a commodity from an image captured by the imaging means. The acquisition means acquires an image of a medium used for online settlement from an image captured by the imaging means. The recording means records the image of the medium acquired by the acquisition means and the information related to the transaction of the commodity specified by the specifying means on a recording medium.

Hereinafter, some embodiments related to the settlement system will be described with reference to the drawings.

### First Embodiment

First, a first embodiment will be described.

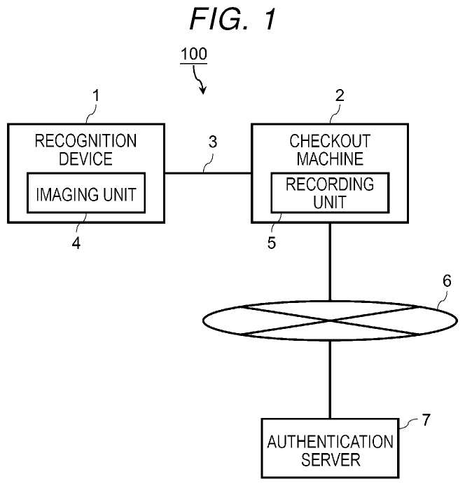

FIG. 1 is a schematic configuration diagram of a settlement system 100 according to the first embodiment. The settlement system 100 includes a recognition device 1 and a checkout machine 2. The settlement system 100 connects the recognition device 1 and the checkout machine 2 by a communication line 3. The communication line 3 may be wired or wireless.

The recognition device 1 includes an imaging unit 4. The imaging unit 4 can be paraphrased as an imaging portion. The recognition device 1 recognizes a commodity from an image captured by the imaging unit 4. For example, the recognition device 1 reads a barcode from an image and recognizes a commodity from the barcode. For example, the recognition device 1 extracts the appearance feature amount of the commodity from the image and recognizes the commodity from the appearance feature amount. Since the object recognition technique using such an image is well known, the detailed description thereof will be omitted here.

The checkout machine 2 includes a recording unit 5. The recording unit 5 can be paraphrased as a recording portion. The recording unit 5 records the data on recording paper. The recording paper on which the data is recorded is dispensed as, for example, a purchase receipt, a credit card slip, a warranty card, a settlement report, an inspection report, or the like. Since the technique of dispensing such recording paper is well known, the detailed description thereof is omitted here.

The settlement system 100 connects the checkout machine 2 to a system network 6 dedicated to the credit card to enable the settlement by a credit card. An authentication server 7 of each credit card issuing company is connected to the system network 6. The authentication server 7 authenticates the credit card based on the credit card data and the like received from the checkout machine 2 via the system network 6 and determines whether to approve or reject the settlement. The authentication server 7 transmits the authentication result to the checkout machine 2 via the system network 6. If the settlement is approved, the checkout machine 2 processes the settlement by the credit card. If the settlement is rejected, the checkout machine 2 makes the settlement by the credit card an error.

In the settlement system 100 having such a configuration, the present embodiment takes measures if the system is offline due to a failure of the system network 6 or a failure of the authentication server 7, that is, if online credit card settlement becomes impossible. The measures will be described in detail below.

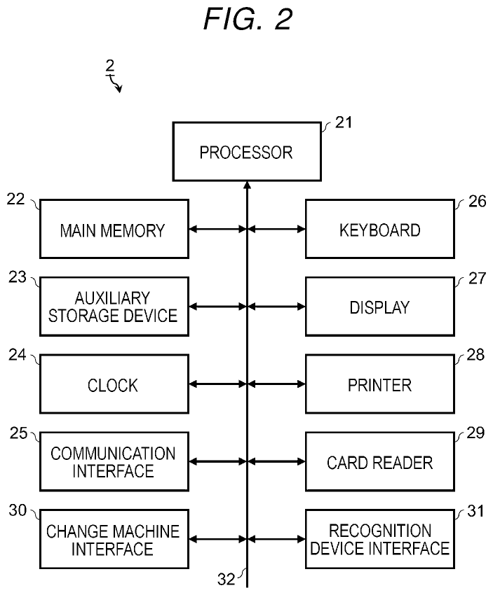

FIG. 2 is a block diagram showing a circuit configuration of a main part of the checkout machine 2. The checkout machine 2 includes a processor 21, a main memory 22, an auxiliary storage device 23, a clock 24, a communication interface 25, a keyboard 26, a display 27, a printer 28, a card reader 29, a change machine interface 30, a recognition device interface 31, a system transmission line 32, and the like. The system transmission line 32 includes an address bus, a data bus, a control signal line, and the like. The system transmission line 32 connects the processor 21 and other parts directly or via a signal input and output circuit, and transmits data signals exchanged therebetween.

The checkout machine 2 configures a computer by connecting the processor 21, the main memory 22, the auxiliary storage device 23, the clock 24, and the communication interface 25 via the system transmission line 32. Then, the checkout machine 2 connects a device such as the keyboard 26, the display 27, the printer 28, and the card reader 29, and a device interface such as the change machine interface 30 and the recognition device interface 31 to the computer via the system transmission line 32.

The processor 21 corresponds to the central portion of the computer. The processor 21 controls each part to implement various functions as the checkout machine 2 according to the operating system or the application program. The processor 21 is, for example, a Central Processing Unit (CPU).

The main memory 22 corresponds to the main memory portion of the computer. The main memory 22 includes a non-volatile memory area and a volatile memory area. The main memory 22 stores an operating system or an application program in a non-volatile memory area. The main memory 22 may store data necessary for the processor 21 to execute processes for controlling each part in a non-volatile or volatile memory area. The main memory 22 uses the volatile memory area as a work area where data is appropriately rewritten by the processor 21. The non-volatile memory area is, for example, a Read Only Memory (ROM). The volatile memory area is, for example, a Random Access Memory (RAM).

The auxiliary storage device 23 corresponds to the auxiliary storage portion of the computer. For example, an Electric Erasable Programmable Read-Only Memory (EEPROM), a Hard Disc Drive (HDD), a Solid State Drive (SSD), or the like can be an auxiliary storage device 23. The auxiliary storage device 23 stores data used by the processor 21 for executing various processes, data created by the processes of the processor 21, and the like. The auxiliary storage device 23 may store the above application program.

The clock 24 tracks the date and time. The processor 21 processes the date and time tracked by the clock 24 as the current date and time.

The communication interface 25 connects the system network 6. The checkout machine 2 performs data communication with an authentication server 7 or the like connected to the system network 6 via the communication interface 25.

The keyboard 26 is a device that includes various function keys necessary as the checkout machine 2, such as a subtotal key, a cancellation key, and a closing key, in addition to a numeric keypad for inputting numerical values, and receives input of various data.

The display 27 is a device that displays various screen information such as a checkout screen and a details screen. The display 27 includes a display for operators and a display for customers. The display 27 may be a touch panel in which a touch sensor is disposed on the screen.

The printer 28 is a device that prints data on receipt paper, and cuts and dispenses a purchase receipt, a credit card slip, a warranty card, a settlement report, an inspection report, and the like. The printer 28 is an example of the recording unit 5.

The card reader 29 is a device that reads data recorded on a card medium such as a credit card, an electronic money card, a point card, or the like. If the card medium is a magnetic card, the card reader 29 is a magnetic card reader. If the card medium is an IC card, the card reader 29 is an IC card reader. The checkout machine 2 may include either a magnetic card reader or an IC card reader as the card reader 29 or may include both. The card reader 29 may be a card reader and writer having the function of writing data to a card.

The change machine interface 30 configures an interface with an automatic change machine (not shown). The change machine interface 30 inputs the data of the money amount inserted into the automatic change machine from the automatic change machine. The change machine interface 30 outputs change data from the checkout machine 2 to the automatic change machine. The automatic change machine that inputs the change data automatically pays out the money equivalent to the change data as change.

The recognition device interface 31 configures an interface with the recognition device 1. The recognition device interface 31 inputs the information recognized by the recognition device 1. The recognition device interface 31 outputs display data and the like from the checkout machine 2 to the recognition device 1.

The checkout machine 2 having such a configuration is generally referred to as a POS (Point Of Sales) terminal, an electronic cash register, a money registration machine, or the like. The checkout machine 2 is not limited to the above-described configuration. For example, the checkout machine 2 may connect a drawer instead of the change machine interface 30. The checkout machine 2 may connect a settlement terminal such as a pin pad instead of the card reader 29. In this case, the checkout machine 2 connects to the system network 6 via the settlement terminal.

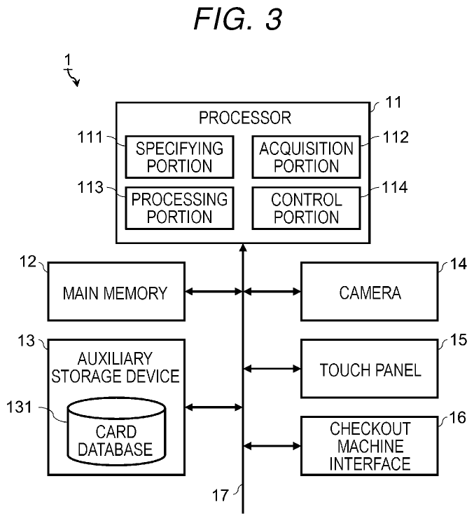

FIG. 3 is a block diagram showing a circuit configuration of a main part of the recognition device 1. The recognition device 1 includes a processor 11, a main memory 12, an auxiliary storage device 13, a camera 14, a touch panel 15, a checkout machine interface 16, a system transmission line 17, and the like. The system transmission line 17 includes an address bus, a data bus, a control signal line, and the like. The system transmission line 17 connects the processor 11 and other parts directly or via a signal input and output circuit, and transmits data signals exchanged therebetween.

The recognition device 1 configures a computer by connecting the processor 11, the main memory 12, and the auxiliary storage device 13 via the system transmission line 17. Then, the recognition device 1 connects a device such as the camera 14, the touch panel 15, and the device interface such as the checkout machine interface 16 to the computer via the system transmission line 17.

The processor 11 corresponds to the central portion of the computer. The processor 11 controls each part to implement various functions as the recognition device 1 according to the operating system or the application program. The processor 11 is, for example, a CPU.

The main memory 12 corresponds to the main memory portion of the computer. The main memory 12 includes a non-volatile memory area and a volatile memory area. The main memory 12 stores an operating system or an application program in a non-volatile memory area. The main memory 12 may store data necessary for the processor 11 to execute processes for controlling each part in a non-volatile or volatile memory area. The main memory 12 uses the volatile memory area as a work area where data is appropriately rewritten by the processor 11. The non-volatile memory area is, for example, a ROM. The volatile memory area is, for example, a RAM.

The auxiliary storage device 13 corresponds to the auxiliary storage portion of the computer. For example, an EEPROM, an HDD, an SSD, or the like can be the auxiliary storage device 13. The auxiliary storage device 13 stores data used by the processor 11 for executing various processes, data created by the processes of the processor 11, and the like. The auxiliary storage device 13 may store the above application program.

The camera 14 is a device that captures an object held over the reading window. The frame images captured by the camera 14 are sequentially written in the image memory. The image memory is, for example, in the volatile memory area of the main memory 12. The camera 14 is an example of the imaging unit 4.

The touch panel 15 functions as a display device and an input device of the recognition device 1. For example, the touch panel 15 displays commodity information such as a commodity name and a price of a commodity recognized by the recognition device 1. For example, the touch panel 15 displays various button images such as a checkout button for instructing the transition to checkout, and receives touch input of the button image.

The checkout machine interface 16 configures an interface with the checkout machine 2. The checkout machine interface 16 outputs the information recognized by the recognition device 1 to the checkout machine 2. The checkout machine interface 16 inputs display data and the like from the checkout machine 2.

The recognition device 1 having such a configuration is generally referred to as a scanner device, a reading device, or the like. The recognition device 1 is not limited to the above-mentioned configuration. For example, the recognition device 1 may include a display and a keyboard instead of the touch panel 15 or in combination with the touch panel 15. Further, the recognition device 1 may be provided with a card reader similar to the card reader 29 included in the checkout machine 2.

Incidentally, as the above-mentioned countermeasure, a control program is installed in the recognition device 1 so that the processor 11 functions as a specifying portion 111, an acquisition portion 112, a processing portion 113, and a control portion 114. The control program is one of the application programs stored in the main memory 12 or the auxiliary storage device 13. The method of installing the control program in the main memory 12 or the auxiliary storage device 13 is not particularly limited. The control program can be recorded on a removable recording medium, or the control program can be distributed by communication via a network and installed in the main memory 12 or the auxiliary storage device 13. The recording medium may be in any form as long as the recording medium can store a program non-temporarily and can be read by a device, such as a CD-ROM or a memory card.

The specifying portion 111 is a function of specifying a commodity from an image captured by the camera 14. The commodity may be specified by recognizing the barcode displayed on the image. The commodity may be specified by the appearance feature amount of the commodity image.

The acquisition portion 112 is a function of acquiring an image of a medium used for online settlement from the above image. The medium is typically a credit card. The medium may be other than a credit card. For example, the medium may be a cash card, an electronic money card, or the like.

The processing portion 113 is a function of making the image of the medium acquired by the acquisition portion 112 invisible while leaving a part of the information required for authentication of online settlement. For example, the credit card information required for authentication of online settlement is the card number, the expiration date, and the name of the holder. By the way, the card number, the expiration date, and the name of the holder are embossed. The information required for authentication of online settlement does not need to include all of the card number, the expiration date, and the name of the holder. Alternatively, other information such as the card issue date may be included.

The control portion 114 is a function of controlling the information related to the transaction of the commodity specified by the specifying portion 111 together with the image of the medium acquired by the acquisition portion 112 or the image of the medium processed by the processing portion 113 to be recorded by the printer 28 of the checkout machine 2. The information related to the transaction of the commodity is, for example, the transaction amount and the transaction date and time. The information related to the transaction of the commodity may be only the transaction amount. The information related to the transaction of the commodity may include information other than the transaction amount and the transaction date and time.

Then, the recognition device 1 manages a card database 131 on the auxiliary storage device 13 to support the functions as the specifying portion 111, the acquisition portion 112, the processing portion 113, and the control portion 114. The card database 131 is a collection of data records generated for each type of credit card that can be used for settlement. Hereinafter, the data record collected and stored in the card database 131 is referred to as a card record 1311. The card database 131 does not need to be managed by the auxiliary storage device 13 of the recognition device 1. For example, the card database 131 may be managed by the auxiliary storage device 23 of the checkout machine 2 connected by the communication line 3.

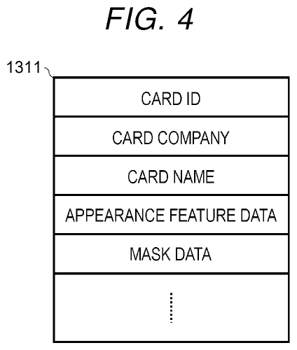

FIG. 4 is a schematic diagram showing a main data structure of the card record 1311. As shown in the drawing, the card record 1311 includes items such as a card ID, a card company, a card name, appearance feature data, and mask data.

The card ID is a unique code (identification information) set for each type of credit card for identifying the type of credit card. The card company is information that specifies the issuing company of the credit card identified by the card ID. The card name is a unique name of the credit card.

Appearance feature data is data representing the appearance features on one side of the credit card. The one side is the side where the card number, the expiration date, the name of the holder, and the like are embossed. Hereinafter, the one side thereof is referred to as a front side and the other side is referred to as a back side. The appearance feature data is data that quantifies the shape, dimension, color, pattern, degree of brightness, and the like of the front side of the credit card.

The mask data is data that masks a part of the image obtained by capturing the front side of the credit card to make the part of the image invisible. In the present embodiment, the area except for the area where the information necessary for credit card authentication, that is, the card number, the expiration date, the name of the holder, and the like are embossed is masked to be made invisible. The embossing positions of the card number, the expiration date, the name of the holder, and the like differ depending on the type of the credit card. However, if the credit cards are of the same type, the embossing position is fixed. Therefore, in the present embodiment, mask data is prepared for each type of the credit card identified by the card ID and stored on the card record 1311.

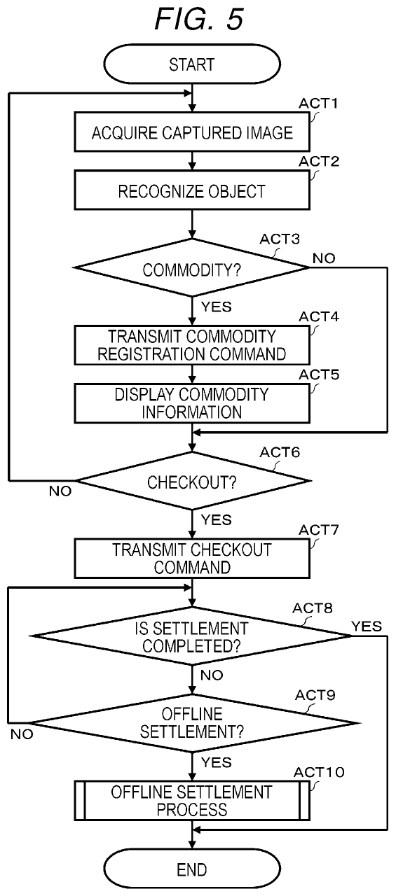

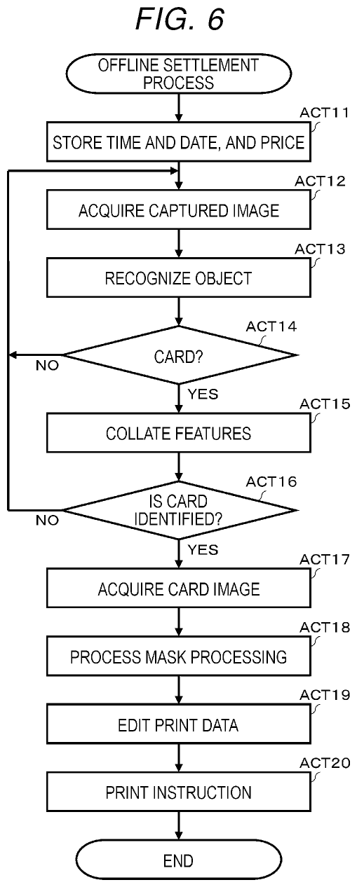

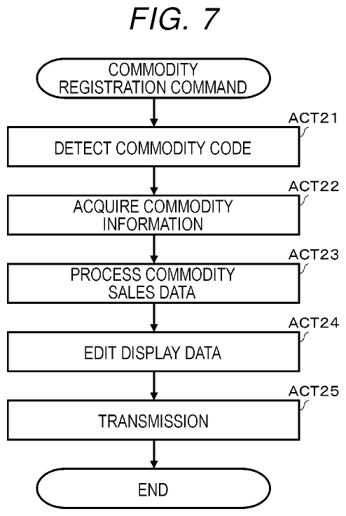

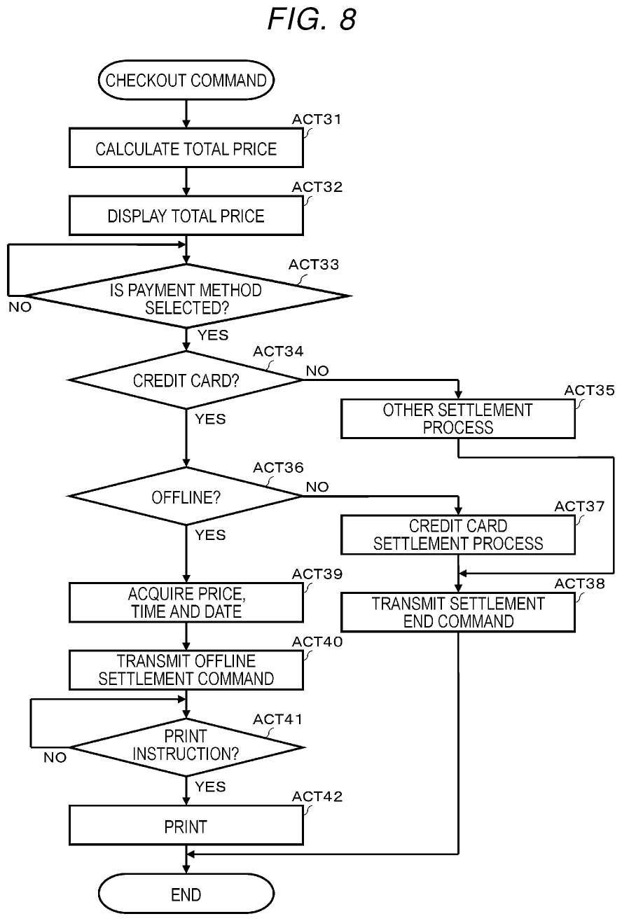

FIGS. 5 and 6 are flowcharts showing a procedure of information processing executed by the processor 11 of the recognition device 1 according to the control program. FIGS. 7 and 8 are flowcharts showing a procedure of information processing executed by the processor 21 of the checkout machine 2 according to the control program. In the following, the main operation of the settlement system 100 will be described using each flowchart. The procedure of information processing described below is an example. If the same effect can be obtained, the procedure or contents can be changed as appropriate.

First, the recognition device 1 and the checkout machine 2 configuring the settlement system 100 are installed in pairs at the checkout place (cash desk) in the store. If the customer offers to settle the purchased commodities, the staff in charge of checkout holds the commodities one by one over the reading window of the recognition device 1. By holding the commodity over the reading window, the commodity is captured by the camera 14.

If the processor 11 of the recognition device 1 receives a transaction start command from, for example, the checkout machine 2, the processor 11 starts information processing of the procedure shown in the flowchart of FIG. 5. First, the processor 11 acquires an image captured by the camera 14, as ACT 1. Then, the processor 11 uses the object recognition technique to specify the commodity from the image as ACT 2.

The processor 11 checks whether or not the commodity is specified, as ACT 3. If the commodity is specified, the processor 11 determines YES in ACT 3 and proceeds to ACT 4. The processor 11 controls to transmit a commodity registration command to the checkout machine 2, as ACT 4. By this control, the commodity registration command is transmitted from the checkout machine interface 16 to the checkout machine 2 via the communication line 3. The commodity registration command includes a commodity code that is identification information of the specified commodity. Here, the processor 11 implements the function as the specifying portion 111 by the processes of ACT 1 to ACT 4.

Upon receiving the commodity registration command by the recognition device interface 31, the processor 21 of the checkout machine 2 starts information processing of the procedure shown in the flowchart of FIG. 7. First, the processor 21 detects the commodity code from the commodity registration command, as ACT 21. The processor 21 acquires commodity information such as a commodity name and price of the commodity identified by the commodity code, as ACT 22. For example, the auxiliary storage device 23 of the checkout machine 2 stores a data file in which commodity information such as a commodity name and price is preset in association with a commodity code of each commodity, that is, a so-called Price Look Up (PLU) file. The processor 21 searches the PLU file and acquires commodity information. The PLU file may be stored in the storage device of the server connected to the outside of the checkout machine 2 instead of the auxiliary storage device 23 of the checkout machine 2.

The processor 21 acquiring the commodity information executes the commodity sales data processing, as ACT 23. Specifically, the processor 21 generates commodity sales data based on the commodity information. The commodity sales data includes items such as the commodity code, the commodity name, the price, the number of items sold, and a sales amount. The processor 21 registers the commodity sales data in the transaction memory. The transaction memory is part of the volatile memory area in the main memory 22.

The processor 21 edits the display data, as ACT 24. The display data includes the commodity name, price, number of items sold, and sales amount of the commodity sales data. The display data may include only the commodity name and the price. The processor 21 controls to transmit the display data to the recognition device 1, as ACT 25. By this control, display data is transmitted from the recognition device interface 31 to the recognition device 1 via the communication line 3. With the above, the processor 21 ends the information processing of the procedure shown in the flowchart of FIG. 7.

Refer back to FIG. 5 for description.

Upon receiving the display data by the checkout machine interface 16, the processor 11 of the recognition device 1 causes the touch panel 15 to display the information on the display data, as ACT 5. As a result, the commodity name, price, and the like of the commodity specified from the image captured by the camera 14 are displayed on the touch panel 15.

The processor 11 checks whether or not the checkout instruction is received, as ACT 6. As described above, the checkout button is displayed on the touch panel 15, and if the checkout button is touch-operated, the processor 11 receives the checkout instruction. If the checkout instruction is not received, the processor 11 determines NO in ACT 6 and returns to ACT 1. The processor 11 acquires the next image captured by the camera 14 and specifies the commodity from the image.

Incidentally, if the object recognition is performed for the image captured by the camera 14 but the commodity cannot be specified, the processor 11 determines NO in ACT 3 and proceeds to ACT 6. That is, the processor 11 waits for the commodity to be specified from the image captured by the camera 14 or for the checkout instruction to be input. Then, if the commodity is specified, the processes shown in ACT 4 and ACT 5 are executed.

If the commodity information such as the commodity name, the price, and the like is displayed on the touch panel 15, the staff in charge of checkout recognizes that the purchased commodity held over the reading window is correctly registered in the checkout machine 2. Then, the staff holds the next purchased commodity over the reading window. In this way, upon recognizing that all the purchased commodities are registered in the checkout machine 2, the staff touches the checkout button.

If the checkout button is touched, the processor 11 recognizes that the checkout instruction is given. The processor 11 determines YES in ACT 6 and proceeds to ACT 7. The processor 11 controls to transmit the checkout command to the checkout machine 2, as ACT 7. By this control, the checkout command is transmitted from the checkout machine interface 16 to the checkout machine 2 via the communication line 3.

Upon receiving the checkout command by the recognition device interface 31, the processor 21 of the checkout machine 2 starts information processing of the procedure shown in the flowchart of FIG. 8. First, the processor 21 calculates the transaction amount based on the commodity sales data registered in the transaction memory, as ACT 31. The transaction amount is the amount charged to the customer. The transaction amount is, for example, the total amount of the commodities purchased by the customer plus the tax amount levied on the commodities. The processor 21 displays the transaction amount on the display 27, as ACT 32.

The processor 21 waits for the payment method to be selected, as ACT 33. For example, the keyboard 26 is arranged with keys for selecting a payment method such as cash, credit card, and electronic money. The staff inputs the key of the payment method desired by the customer.

If the payment method is selected, the processor 21 determines YES in ACT 33 and proceeds to ACT 34. The processor 21 checks whether or not the credit card is selected as the payment method, as ACT 34. If a payment method other than the credit card is selected, the processor 21 determines NO in ACT 34 and proceeds to ACT 35. The processor 21 executes the settlement processing according to the selected payment method, as ACT 35.

For example, if cash is selected as the payment method, the processor 21 waits for cash to be inserted into the automatic change machine. Then, if cash equal to or greater than the transaction amount is inserted, the difference between the transaction amount and the inserted cash is displayed as change on the display 27 and the change data is output to the automatic change machine. Thus, change is paid out from the automatic change machine. Further, the processor 21 generates print data of the purchase receipt and controls the printer 28 to dispense the purchase receipt. In this way, a purchase receipt is dispensed in which the transaction details, the payment amount in cash, the change amount, and the like are recorded, and the staff hands over the purchase receipt to the customer together with the change.

If electronic money is selected as the payment method, the processor 21 waits for the data of the electronic money card to be read by the card reader 29. Then, if the data of the electronic money card holding the electronic money amount equal to or greater than the transaction amount is read, the transaction amount is subtracted from the electronic money amount. Further, the processor 21 generates print data of the purchase receipt and controls the printer 28 to print the purchase receipt. In this way, a purchase receipt is dispensed in which the transaction details and the payment amount by electronic money are recorded, and the staff hands over the purchase receipt to the customer.

If the credit card is selected as the payment method, the processor 21 determines YES in ACT 34 and proceeds to ACT 36. The processor 21 checks whether or not the system network 6 is offline, as ACT 36. If the system network 6 is not offline, that is, if communication with the authentication server 7 is established, the processor 21 determines NO in ACT 36 and proceeds to ACT 37. The processor 21 executes the credit settlement processing, as ACT 37.

Specifically, the processor 21 controls the card reader 29 to read the credit card data and transmit an authentication command including the credit card data and the transaction amount. By this control, the authentication command is transmitted to the authentication server 7 of the credit card issuing company via the system network 6. The authentication server 7 performs a settlement authentication such as whether the credit card is valid and whether the transaction amount is within the allowable range. Then, the authentication result is returned from the authentication server 7 to the checkout machine 2.

If the credit card settlement is approved by the authentication server 7, the processor 21 controls the printer 28 to dispense the credit slip. Thus, a credit slip in which the details of the credit transaction are recorded is dispensed and the staff hands over the credit slip to the customer.

If the settlement processing according to the payment method is completed by the process of ACT 35 or ACT 37 described above, the processor 21 proceeds to ACT 38. The processor 21 controls to transmit a settlement end command to the recognition device 1, as ACT 38. By this control, the settlement end command is transmitted from the recognition device interface 31 to the recognition device 1 via the communication line 3. With the above, the processor 21 ends the information processing of the procedure shown in the flowchart of FIG. 8.

On the other hand, if the credit card is selected as the payment method but the system network 6 is offline, the processor 21 determines YES in ACT 36 and proceeds to ACT 39. The processor 21 acquires the transaction date and time and the transaction amount, as ACT 39. The transaction date and time is, for example, the date and time tracked by the clock 24 if the checkout command is received. The processor 21 controls to transmit an offline settlement command to the recognition device 1, as ACT 40. By this control, the offline settlement command is transmitted from the recognition device interface 31 to the recognition device 1 via the communication line 3. The offline settlement command includes the transaction date and time and the transaction amount.

Refer back to FIG. 5 for description.

Upon controlling the transmission of the checkout command, the processor 11 of the recognition device 1 checks whether or not the settlement end command is received, as ACT 8. If the settlement end command is not received, the processor 11 determines NO in ACT 8 and proceeds to ACT 9. The processor 11 checks whether or not the offline settlement command is received, as ACT 9. If the offline settlement command is not received, the processor 11 determines NO in ACT 9 and returns to ACT 8. Here, the processor 11 waits for receiving the settlement end command or the offline settlement command.

Upon receiving the settlement end command via the checkout machine interface 16, the processor 11 determines YES in ACT 8. Receiving the settlement end command means that the settlement is completed in the checkout machine 2. Therefore, the processor 11 ends the information processing of the procedure shown in the flowchart of FIG. 5.

On the other hand, if the offline settlement command is received via the checkout machine interface 16, the processor 11 determines YES in ACT 9 and proceeds to ACT 10. Receiving the offline settlement command means that the system is offline due to a failure of the system network 6 or a failure of the authentication server 7 and an online credit card settlement cannot be made. Therefore, the processor 11 executes the offline settlement processing, as ACT 10.

FIG. 6 is a flowchart showing a specific procedure of offline settlement processing. Upon entering the offline settlement processing, the processor 11 acquires the transaction date and time and the transaction amount from the offline settlement command, as ACT 11. Further, the processor 11 acquires the image captured by the camera 14, as ACT 12. Then, as ACT 13, the processor 11 uses the object recognition technique to specify a medium used for online settlement, for example, a credit card, from the image.

The processor 11 checks whether or not the credit card is specified, as ACT 14. If the credit card cannot be specified, the processor 11 determines NO in ACT 14 and returns to ACT 12. In this way, the processor 11 sequentially acquires the images captured by the camera 14 and waits for the credit card to be specified by the object recognition process.

If the credit card is specified, the processor 11 determines YES in ACT 14 and proceeds to ACT 15. As ACT 15, the processor 11 calculates the feature amount of the image of the portion where the credit card is specified and collates the feature amount with the appearance feature data of each credit card with reference to the card database 131. Then, the processor 11 checks whether or not the credit card having similar appearance features is identified, as ACT 16. If the credit card cannot be identified, the processor 11 determines NO in ACT 16 and returns to ACT 12.

If the credit card is identified, the processor 11 determines YES in ACT 16 and proceeds to ACT 17. As ACT 17, the processor 11 cuts out the area where the credit card is displayed, from the frame image in which the credit card is identified and acquires the image of the credit card. Here, the processor 11 implements the function as the acquisition portion 112 by the processes of ACT 12 to ACT 17.

The processor 11 executes mask processing on the image of the credit card, as ACT 18. That is, the processor 11 acquires the mask data of the identified credit card from the card database 131. Then, the processor 11 obscures the image of the credit card with the mask data, thereby making a part of the image invisible. Specifically, the processor 11 makes the image of the area of the credit card image invisible, excluding the embossed card number, expiration date, and name of the holder. Here, the processor 11 implements the function as the processing portion 113 by the process of ACT 18.

After finishing the mask processing, the processor 11 edits the print data, as ACT 19. The print data is data including a credit card image partially invisible by the mask processing, the information about the transaction amount and the transaction date and time acquired by the process of ACT 11, and a signature column. The signature column is a blank for the credit card user to sign. The processor 11 instructs the checkout machine 2 to print the print data, as ACT 20. By this command, print data is transmitted from the recognition device 1 to the checkout machine 2 via the communication line 3. The processor 11 completing the print command ends the offline settlement processing. Thus, the processor 11 ends the information processing of the procedure shown in the flowchart of FIG. 5.

Refer back to FIG. 8 for description.

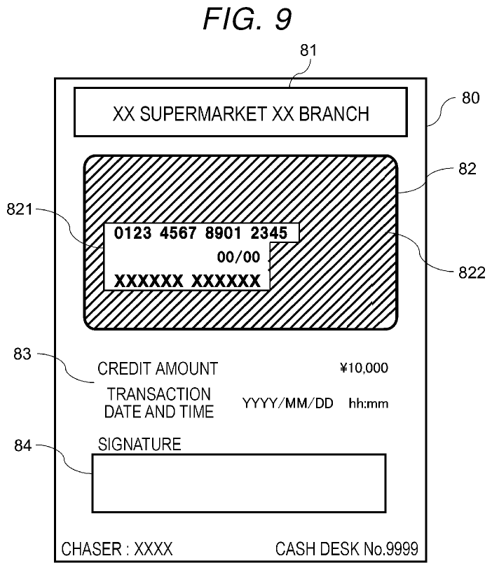

Upon controlling the transmission of the offline settlement command, the processor 21 of the checkout machine 2 waits for the print command, as ACT 41. Upon receiving the print command via the recognition device interface 31, the processor 21 determines YES in ACT 41 and proceeds to ACT 42. The processor 21 controls the printer 28 to print the print data included in the print command on the receipt paper, as ACT 42. Thus, for example, an offline settlement receipt 80 having a layout shown in FIG. 9 is printed and dispensed by the printer 28. Here, the processor 11 implements the function as the control portion 114 by the processes of ACT 19 and ACT 20.

As shown in FIG. 9, the offline settlement receipt 80 is printed with a credit card image 82, a transaction amount (credit amount), transaction date and time 83, a signature column 84, and the like, as well as header information 81 peculiar to the receipt, such as a store name or a logo. In the credit card image 82, a second area 822 excluding a first area 821 of the embossed card number, expiration date, and name of the holder is made invisible by the mask processing.

In this way, the transaction amount, and transaction date and time are recorded on the offline settlement receipt 80, together with the information required for authentication such as the card number, the expiration date, and the name of the holder, which are embossed on the credit card. A signature column 84 is also formed. Therefore, if the credit card user signs the signature column 84, the offline settlement receipt 80 fulfills the same function as the printed matter printed by the dedicated printer in the related art. That is, even if the system is offline due to a failure of the system network 6 or a failure of the authentication server 7, settlement by a credit card is possible.

Moreover, the recognition device 1 and the checkout machine 2 for dispensing the offline settlement receipt 80 are devices that are always available at the checkout place (cash desk) in the store. Therefore, if the system is offline, it is possible to promptly shift to offline-compatible credit card settlement. As a result, it is possible to improve the reliability of the customer to the store without making the customer wait or requesting a settlement method other than a credit card. In addition, the store can also eliminate the need for a dedicated printer, which has the advantage of reducing management costs.

Also, since the staff only needs to hold the credit card over the reading window, the operation is easy and does not impose a burden. Incidentally, if the staff holds the back side of the credit card over the reading window, the credit card is not specified, and thus, the offline settlement receipt 80 is not dispensed. The back side of the credit card contains important information from the viewpoint of security, such as the card user's signature and security number. However, since the important information is never recorded on the offline settlement receipt 80, the staff can take an offline response without hesitation.

On the other hand, the logo of the credit card issuing company is displayed in the second area 822 on the front side of the credit card. In addition, a photo of the cardholder's face may be displayed. In the present embodiment, the second area 822 is made invisible by mask processing. Therefore, it also has the effect of preventing the information about the credit card issuing company or the personal information of the cardholder from leaking from the offline settlement receipt 80.

### Second Embodiment

By the way, the offline settlement receipt is transmitted from the store to the credit card issuing company. Upon receiving the transmission, the person in charge of the credit card issuing company needs to register information such as the card number, expiration date, name of the holder, transaction date and time, transaction amount, and the like recorded on the offline settlement receipt in the authentication server 7. The registration work is very burdensome. Therefore, next, a settlement system according to a second embodiment that can reduce the burden of the registration work described above will be described. Here, the points different from those of the first embodiment will be described in detail, and the same portions as those of the first embodiment are denoted by the same reference numerals and the description thereof will be omitted.

Also in the second embodiment, the settlement system includes a recognition device and the checkout machine 2. Then, as the checkout machine 2, the one in the first embodiment can be applied as it is. The recognition device differs from that of the first embodiment in some functions. Therefore, in the following, the recognition device according to the second embodiment will be referred to as a recognition device 10.

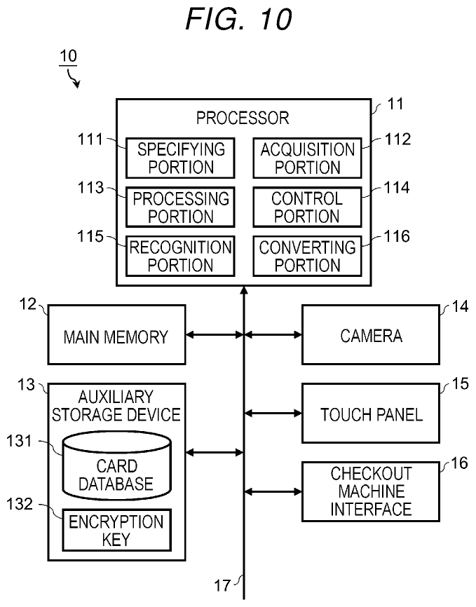

FIG. 10 is a block diagram showing a circuit configuration of a main part of the recognition device 10. The recognition device 10 differs from the recognition device 1 of the first embodiment in some functions of the processor 11. That is, a control program is installed in the recognition device 10 so that the processor 11 functions as a recognition portion 115 and a converting portion 116 in addition to the specifying portion 111, the acquisition portion 112, the processing portion 113, and the control portion 114.

The recognition portion 115 is a function of recognizing information required for authentication of online settlement from an image of a medium acquired by the acquisition portion. As described in the first embodiment, the information required for authentication of online settlement is, for example, the card number, the expiration date, and the name of the holder. The recognition portion 115 specifies an area in which the card number, the expiration date, and the name of the holder are embossed from the image of the medium, and executes character recognition processing on the image in the specified area to recognize the card number, the expiration date, and the name of the holder.

The converting portion 116 is a function of converting the information recognized by the recognition portion into a code that can be read by a code reading device. The code reading device is, for example, a device for reading a two-dimensional code such as a QR code (registered trademark). The converting portion 116 encrypts the information recognized by the recognition portion with a predetermined encryption key and converts the information into a code. Therefore, the recognition device 10 stores the encryption key 132 for encrypting the code in the auxiliary storage device 13.

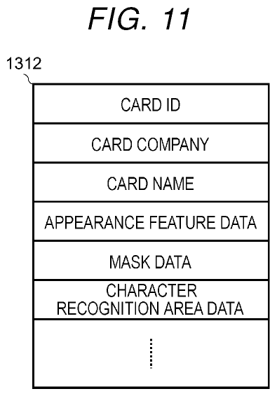

FIG. 11 is a schematic diagram showing a main data structure of a card record 1312 collected and stored in the card database 131 in the second embodiment. As shown in the drawing, the card record 1312 includes items of character recognition area data in addition to a card ID, a card company, a card name, appearance feature data, mask data, and the like.

The character recognition area data is data for specifying an area in which the card number, expiration date, and name of the holder are embossed in the credit card identified by the card ID.

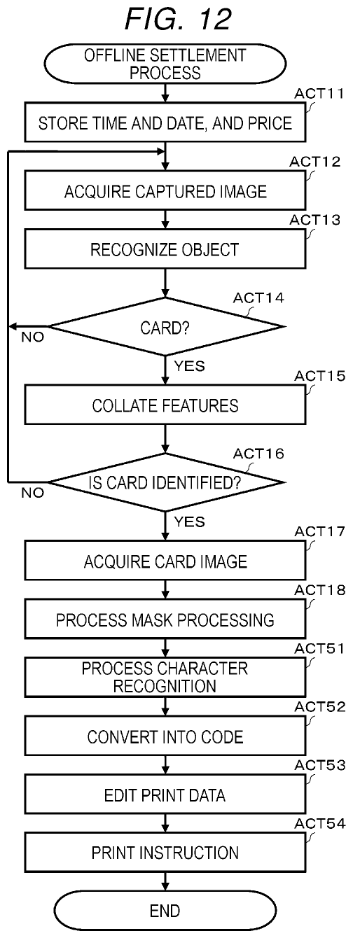

FIG. 12 is a flowchart showing a specific procedure of offline settlement processing according to the second embodiment. In FIG. 12, the processing steps common to the flowchart of the offline settlement processing of the first embodiment shown in FIG. 6 are designated by common reference numerals. That is, if the processor 11 enters the offline settlement processing, the processor 11 executes the same processes as in the first embodiment from ACT 11 to ACT 18.

If the mask processing of ACT 18 is completed, the processor 11 executes the character recognition process, as ACT 51. That is, the processor 11 acquires the character recognition area data of the identified credit card from the card record 1312. Then, the processor 11 extracts an area specified by the character recognition area data from the image of the credit card acquired by the process of ACT 17 and executes the character recognition process for the extracted area by using the application program for character recognition. By this process, the characters of the card number, the expiration date, and the name of the holder embossed in the area specified by the character recognition area data are recognized. Here, the processor 11 implements the function as the recognition portion 115 by the process of ACT 51.

The processor 11 converts the recognized characters, that is, the information about the card number, the expiration date, and the name of the holder, and the information about the transaction date and time and the transaction amount acquired by the process of ACT 11 into a code readable by the code reading device, as ACT 52. For example, the processor 11 converts the information into a two-dimensional code such as a QR code (registered trademark). At this time, the processor 11 encrypts at least the card number with the encryption key 132 and then converts the card number into the two-dimensional code. The information to be encrypted is not limited to the card number. At least one of the expiration date, holder information, transaction amount, or transaction date and time may be encrypted together with the card number and then converted into the two-dimensional code. Here, the processor 11 implements the function as the converting portion 116 by the process of ACT 52.

The processor 11 edits the print data, as ACT 53. The print data is data including a credit card image made partially invisible by mask processing, information about the transaction amount, and the transaction date and time acquired by the process of ACT 11, the two-dimensional code converted by the process of ACT 52, and a signature column. The processor 11 instructs the checkout machine 2 to print the print data, as ACT 54. By this instruction, print data is transmitted from the recognition device 10 to the checkout machine 2 via the communication line 3. The processor 11 completing the print command ends the offline settlement processing.

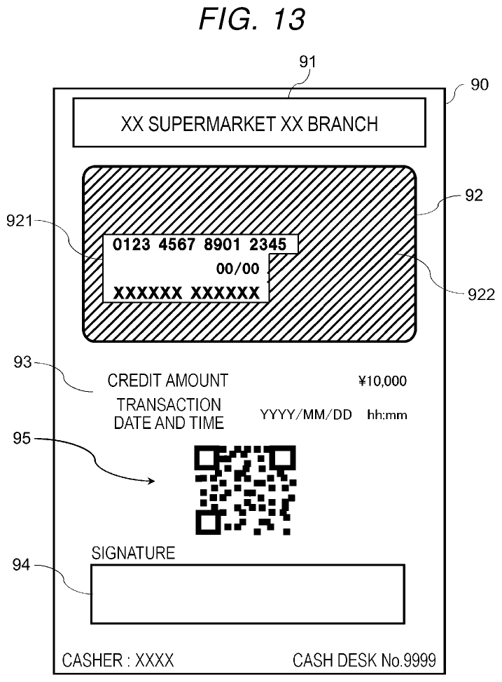

Thus, in the second embodiment, for example, an offline settlement receipt 90 having a layout shown in FIG. 13 is printed and dispensed by the printer 28. As shown in FIG. 13, in the offline settlement receipt 90, a two-dimensional code 95 is printed in addition to a credit card image 92, a transaction amount (credit amount), transaction date and time 93, a signature column 94, and the like, as well as header information 91 peculiar to the receipt, such as a store name or a logo. In the credit card image 92, a second area 922 excluding a first area 921 of the embossed card number, expiration date, and name of the holder is made invisible by the mask processing.

The two-dimensional code 95 is a two-dimensional code obtained by converting the information about the card number, the expiration date, and the name of the holder of the credit card, and the information about the transaction date and time, and the transaction amount into a two-dimensional code. At least the card number is encrypted by the encryption key 132.

The offline settlement receipt 90 is transmitted from the store to the credit card issuing company. Upon receiving the transmission, the person in charge of the credit card issuing company reads the two-dimensional code 95 recorded on the offline settlement receipt 90 with a code reader. Then, the information processing device connected to the code reader, for example, a personal computer, acquires the information about the card number, the expiration date, and the name of the holder of the credit card, included in the two-dimensional code 95, and the information about the transaction date and time, and the transaction amount. At this time, since the card number is encrypted by the encryption key 132, the card number is decrypted by the decryption key corresponding to the encryption key 132. The person in charge may upload the information about the card number, the expiration date, and the name of the holder of the credit card, acquired by the information processing device, and the information about the transaction date and time, and the transaction amount to the authentication server 7. That is, the person in charge can greatly reduce the efforts of registering the information such as the card number, the expiration date, the name of the holder, the transaction date and time, and the transaction amount recorded on the offline settlement receipt 90 in the authentication server 7.

The embodiment of the settlement system is described above but the embodiment is not limited thereto.

In the above embodiment, the processing portion 113 makes the second region 822 or 922, which is a part of the image of the credit card, invisible by the mask processing. The processing for invisibility is not limited to mask processing. The processing may be a process such as blurring or mosaic processing. Further, the processing may be trimming processing for removing the invisible area.

In the above embodiment, the embossed area is visualized. The area to be visualized does not necessarily need to be the embossed area. Even for a medium on which information required for authentication of online settlement is displayed by a method other than embossing, the same effect as that of the present embodiment can be obtained by visualizing the display area or making the area other than the display area invisible.

In the second embodiment, the case where the converting portion 116 converts the information recognized by the recognition portion 115 into the two-dimensional code 95 is exemplified. The code is not limited to the two-dimensional code 95. Any code that can be read by a code reading device, such as a bar code, may be used.

In the above embodiment, the settlement system 100 in which the recognition device 1 and the checkout machine 2 are separated is exemplified. The settlement system may be a system in which the recognition device 1 and the checkout machine 2 are integrated, such as a self-service POS terminal or the like.

In the above embodiment, the processor 21 of the checkout machine 2 recognizes whether or not the system network 6 is offline, and if the system network is offline, an offline settlement command is transmitted to the recognition device 1. In this regard, for example, the checkout machine 2 or the recognition device 1 includes a mode switch for manually switching to the offline mode. Then, if the offline mode is selected by the mode switch, the recognition device 1 forcibly executes the offline settlement processing. Even with such a configuration, the same effect as that of the present embodiment can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A settlement system, comprising:
an imaging component;
a specifying component for specifying a commodity from an image captured by the imaging component;
an acquisition component for acquiring an image of a medium used for online settlement from the image captured by the imaging component; and
a recording component for recording the image of the medium acquired by the acquisition component and the information related to the transaction of the commodity specified by the specifying component on a recording medium.

2. The settlement system according to claim 1, further comprising:
a processing component for making the image of the medium acquired by the acquisition component invisible while leaving a part of information required for authentication of an online settlement, wherein
the recording component records an image of the medium processed by the processing component.

3. The settlement system according to claim 1, further comprising:
a recognition component for recognizing information required for authentication of the online settlement from the image of the medium acquired by the acquisition component; and
a converting component for converting the information recognized by the recognition component into a code readable by a code reading device, wherein
the recording component further records the code converted by the converting component on the recording medium.

4. The settlement system according to claim 3, wherein
the converting component encrypts the information recognized by the recognition component with a predetermined encryption key and converts the code.

5. The settlement system according to claim 3, wherein
the recognition component is a barcode reader.

6. A recognition device comprising:
an imaging component;
a communication component for communicating with a checkout machine provided with a recording component;
a specifying component for specifying a commodity from an image captured by the imaging component;
an acquisition component for acquiring an image of a medium used for online settlement from the image captured by the imaging component; and
a controller for controlling the recording component of the checkout machine to record the image of the medium acquired by the acquisition component and information related to a transaction of the commodity specified by the specifying component.

7. The recognition device according to claim 6, further comprising:
a processing component for making the image of the medium acquired by the acquisition component invisible while leaving a part of information required for authentication of an online settlement; and
a recording component that records an image of the medium processed by a processing component.

8. The recognition device according to claim 6, further comprising:
a recognition component for recognizing information required for authentication of the online settlement from the image of the medium acquired by the acquisition component;
a converting component for converting the information recognized by the recognition component into a code readable by a code reading device; and
a recording component further records the code converted by the converting component on the recording medium.

9. The recognition device according to claim 8, wherein
the converting component encrypts the information recognized by the recognition component with a predetermined encryption key and converts the code.

10. The recognition device according to claim 8, wherein
the recognition component is a barcode reader.

11. The recognition device according to claim 6, wherein
the communication component communicates with the checkout machine in a wired manner.

12. The recognition device according to claim 6, wherein
the communication component communicates with the checkout machine in a wireless manner.

13. A method for causing a computer of a recognition device for communicating with a checkout machine, to perform:
specifying a commodity from an image captured by an imaging component;
acquiring an image of a medium used for online settlement from the image captured by the imaging component; and
controlling a recording component of the checkout machine to record the image of the medium acquired by an acquisition component and information related to a transaction of the commodity specified by a specifying component.

14. The method according to claim 13, further comprising:
making the image of the medium acquired by the acquisition component invisible while leaving a part of information required for authentication of an online settlement; and
recording an image of the medium processed by a processing component.

15. The method according to claim 13, further comprising:
recognizing information required for authentication of the online settlement from the image of the medium acquired by the acquisition component;
converting the information recognized into a code readable by a code reading device; and
recording the code converted on the recording medium.

16. The method according to claim 15, wherein
encrypting the information recognized with a predetermined encryption key and converting the code.

17. The method according to claim 15, wherein
recognizing comprises reading a barcode.

18. The method according to claim 13, wherein
communicating comprises communicating with the checkout machine in a wired manner.

19. The method according to claim 13, wherein
communicating comprises communicating with the checkout machine in a wireless manner.
